(19) United States
(12) Patent Application Publication
(10) Pub. No.: US 2014/0092056 A1
(43) Pub. Date: Apr. 3, 2014

(54) TOUCH APPARATUS AND TOUCH SENSING METHOD THEREOF

(71) Applicant: AU OPTRONICS CORPORATION, Hsinchu (TW)

(72) Inventors: Sin-Guo Jhou, Hsinchu County (TW); Yu-Min Hsu, Changhua County (TW); Yung-Tse Cheng, Hsinchu City (TW)

(73) Assignee: AU OPTRONICS CORPORATION, Hsinchu (TW)

(21) Appl. No.: 13/723,165

(22) Filed: Dec. 20, 2012

(30) Foreign Application Priority Data
Oct. 2, 2012 (TW) 101136410

(51) Int. Cl. G06F 3/044

(52) U.S. Cl. CPC G06F 3/044
USPC 345/174

(57) ABSTRACT

The touch apparatus includes a touch panel, a signal generation unit for generating a driving signal, an inductor, and a detection unit. The touch panel has touch areas. The inductor is coupled between the touch panel and the signal generation unit and transmits the driving signal to the touch areas. The detection unit is coupled to the touch panel and the signal generation unit, receives touch signals from the touch areas, and calculates capacitance variances of the touch areas according to the touch signals and an output timing of the driving signal, so as to detect a touch point of the touch panel. A frequency of the driving signal is equal to a resonant frequency of a reference capacitance of the touch panel and an inductance of the inductor.

### CROSS-REFERENCE TO RELATED APPLICATION

This application claims the priority benefit of Taiwan application serial no. 101136410, filed on Oct. 2, 2012. The entirety of the above-mentioned patent application is hereby incorporated by reference herein and made a part of this specification.

### BACKGROUND OF THE INVENTION

1. Field of the Invention

The invention relates to a touch apparatus. More particularly, the invention relates to a capacitive touch apparatus.

2. Description of Related Art

With the rapid development and advancement of wireless mobile communication and information appliances, input devices of various information products have been changed from conventional keyboards or mice to touch panels, so as to bridge the gap between human and computer devices through facilitating the use of the information products, reducing the volume of the information products, and integrating the information products with intuitive design. Among the touch panels, the use of capacitive touch panels renders favorable touch sensing and detection results, and therefore a number of touch sensing technologies of the capacitive touch panel have been correspondingly developed.

According to a conventional touch sensing mechanism, in a normal sensor IC, the number of charging and discharging a sensing capacitor with different capacitances is calculated, so as to determine whether the corresponding touch areas are touched. For instance, the sensor IC may set a threshold number of charging and discharging actions. If the actual number of charging and discharging actions is greater than the threshold number, the sensor IC determines that the corresponding touch areas are touched. This is how the conventional touch sensing mechanism is implemented. Nonetheless, the sensitivity of said sensing mechanism is not impressive. Thus, if a touch action is activated not by a finger but by a stylus or other means with the small contact area, due to the relatively small capacitance variance, the sensor IC may make erroneous determination and is not able to accurately determine whether the touch panel is touched.

### SUMMARY OF THE INVENTION

The invention is directed generally to a touch apparatus and particularly to a capacitive touch apparatus. According to the principle of resonance, peak voltage variances of touch signals are detected for determining capacitance variances of a touch panel, and thereby the sensing sensitivity of the touch apparatus may be enhanced.

In an embodiment of the invention, a touch apparatus that includes a touch panel, a signal generation unit, an inductor, and a detection unit is provided. The touch panel has a plurality of touch areas. The signal generation unit is used for generating a driving signal. The inductor is coupled between the touch panel and the signal generation unit and transmits the driving signal to the touch areas. The detection unit is coupled to the touch panel and the signal generation unit, receives a plurality of touch signals output from the touch areas, and calculates capacitance variances of the touch areas according to the touch signals and an output timing of the driving signal, so as to detect a touch point on the touch panel. Here, a frequency of the driving signal is equal to a resonant frequency of a reference capacitance of the touch panel and an inductance of the inductor.

In another embodiment of the invention, a touch sensing method is provided. The touch sensing method includes: sequentially transmitting a driving signal to a plurality of touch areas of a touch panel through an inductor; receiving a plurality of touch signals correspondingly output from the touch areas; calculating capacitance variances of the touch areas according to the touch signals and an output timing of the driving signal; detecting a touch point on the touch panel according to the capacitance variances of the touch areas.

Several exemplary embodiments accompanied with figures are described in detail below to further describe the invention in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a schematic view illustrating a touch apparatus according to an embodiment of the invention.

FIG. 2 is a schematic view illustrating circuitry in a detection unit according to an embodiment of the invention.

FIG. 3A and FIG. 3B are schematic views illustrating a signal waveform of a touch apparatus according to an embodiment of the invention.

FIG. 4 is a schematic view illustrating a touch apparatus according to another embodiment of the invention.

FIG. 5 is a schematic view illustrating a touch apparatus according to still another embodiment of the invention.

FIG. 6 is a schematic view illustrating a touch sensing method according to an embodiment of the invention.

### DETAILED DESCRIPTION OF DISCLOSED EMBODIMENTS

To improve the sensitivity of a capacitive touch panel, the principle of resonance of a capacitance and an inductance is applied to detect a touch point on the touch panel.

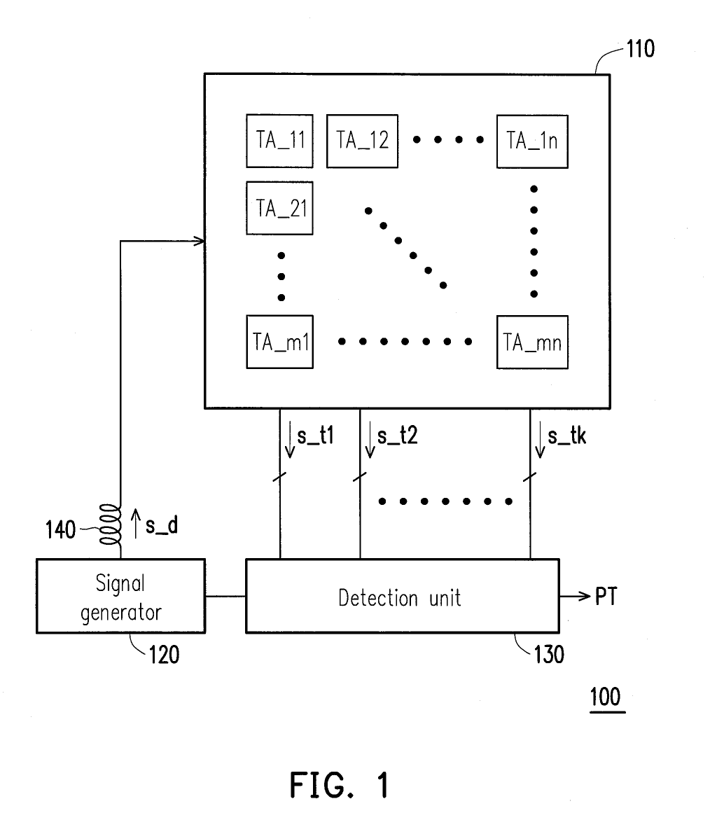

FIG. 1 is a schematic view illustrating a touch apparatus according to an embodiment of the invention. With reference to FIG. 1, according to the present embodiment of the invention, the touch apparatus 100 includes a touch panel 110, a signal generator 120, a detection unit 130, and an inductor 140. The touch panel 110 has a plurality of touch areas TA_{—}11 to TA_nm. Here, m and n are positive integers and are determined based on the requirement for resolution of the touch panel 110. The signal generator 120 is used for generating a driving signal s_d. The inductor 140 is coupled between the touch panel 110 and the signal generator 120 and transmits the driving signal s_d to the touch areas TA_{—}11 to TA_nm.

The detection unit 130 is coupled to the touch panel 110 and the signal generator 120. Besides, the detection unit 130 receives a plurality of touch signals st₁ to s_tk output from the touch areas TA_{—}11 to TA_nm; here, k is a positive integer and may be determined according to the number of the touch areas TA_{—}11 to TA_nm. According to the touch signals s_t1 to s_tk and an output timing of the driving signal s_d, the detection unit 130 calculates capacitance variances of the touch areas TA_{—}11 to TA_mn, so as to detect and output a touch point PT (i.e., a touch location) on the touch panel 110.

In the present embodiment, the touch panel 110 is a capacitive touch panel, and thus whether a touch event occurs in a touch area is sensed by detecting the capacitance variance of the corresponding touch area.

Alternatively, the touch panel 110 may also be a mutual capacitance touch panel or a self capacitance touch panel. The mutual capacitance touch panel outputs sensing signals s_t1 to s_tk corresponding to the sensed capacitance variance in the mutual capacitor between electrodes in the touch panel; by contrast, the self capacitance touch panel outputs sensing signals s_t1 to s_tk corresponding to the sensed capacitance variance between the ground and each electrode in the touch sensing panel.

Particularly, in the present embodiment, equivalent circuit of each touch area TA_{—}11 to TA_nm in the touch panel and the inductor 140 may respectively have an equivalent serial circuit structure to which the resonant circuit principle is applied; therefore, the equivalent capacitance C of each touch area TA_{—}11 to TA_mn that is not touched and the inductance L of the inductor 140 may be offset and the equivalent serial circuit structure is equalized as a resistor circuit. Here, the frequency of the driving signal s_d is equal to a resonant frequency of the resonant circuit:

$$\frac{1}{2 π} \sqrt{LC}$$

That is, the equivalent impedance of the serial circuit structure is determined by the inductance L of the inductor 140 and the equivalent capacitance C of the corresponding touch areas TA_{—}11 to TA_nm. According to the present embodiment, the inductance L of the inductor 140 has a fixed value, and the capacitance variance of the touch panel occurs if any of the touch areas TA_{—}11 to TA_nm is touched. Hence, the equivalent impedance corresponding to each touch areas TA_{—}11 to TA_nm may be changed together with the varied equivalent capacitance C of the corresponding touch areas TA_{—}11 to TA_mn. At this time, peak voltages of the touch signals s_t1 to s_tk of the corresponding touch areas TA_{—}11 to TA_nm are also altered. Namely, the variances in the peak voltages of the touch signals s_t1 to s_tk are relevant to the capacitance variances of the touch areas TA_{—}11 to TA_nm.

To be specific, in the touch apparatus 100, the signal generator 120 may generating the driving signal s_d, and the frequency of the driving signal s_d is equal to a resonant frequency of the inductance L of the inductor 140 and a reference capacitance C of the untouched touch panel 110. According to the present embodiment, the reference capacitance C may be an average of capacitances corresponding to the untouched touch areas TA_{—}11 to TA_nm or an average of a maximum capacitance and a minimum capacitance of capacitances corresponding to the untouched touch areas TA_{—}11 to TA_mn. According to another embodiment, the reference capacitance C may also be an average of capacitances corresponding to the touched touch areas TA_{—}11 to TA_mn or an average of the maximum capacitance and the minimum capacitance of capacitances corresponding to the touched touch areas TA_{—}11 to TA_mn. Note that the reference capacitance C may be calculated in other manner and thus will not be described hereinafter, and here the untouched capacitance is the reference capacitance C, for instance.

In view of the above, when the touch panel 110 is initialized, no phase change occurs between the driving signal s_d and the touch signals s_t1 to s_tk. That is, when the touch panel 110 is not touched, and the frequency of the driving signal s_d is equal to the aforesaid resonant frequency, the detection unit 130 may record the peak voltages of the touch signals s_t1 to s_tk as peak base voltages.

As the touch panel 110 is touched and thus renders phase shift between the driving signal s_d and the touch signals to s_tk, the detection unit 130 stores the touch signals s_t1 to s_tk in a capacitor and detects a peak voltage in a stable state. When the capacitance variance rate is less than 10%, the capacitance variances and the voltage variances are linearly and positively correlated to each other, and thus the capacitance variances of the touch areas TA_{—}11 to TA_nm may be determined according to the variances in the peak voltages. In other words, given that any of the touch areas TA_{—}11 to TA_mn of the touch panel 110 is touched, the detection unit 130 may calculate the capacitance variances of the touch areas TA_{—}11 to TA_mn according to the variances in the peak voltages of the corresponding touch signals s_t1 to s_tk, so as to further detect and output the touch point PT on the touch panel 110.

If the detection unit 130 determines that the capacitance variance rate is greater than 10%, the detection unit 130 may control a switch (not shown) to be optionally coupled to the inductor with different inductances in case that the capacitance variance rate is greater than 10%, e.g., within a range from 10% to 20%, so as to ensure the linear positive correlation between the capacitance variances and the voltage variances. The invention is not limited thereto.

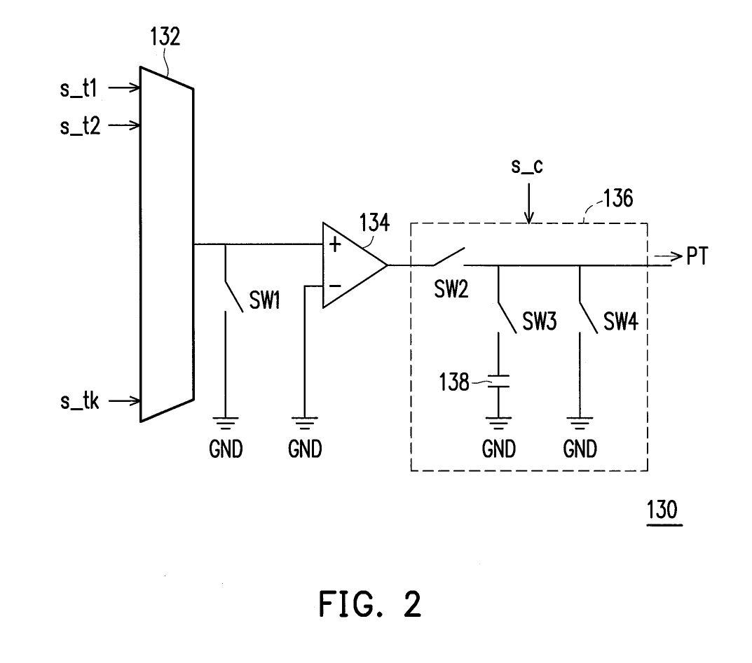

FIG. 2 is a schematic view illustrating circuitry in a detection unit according to an embodiment of the invention, and the touch sensing method is further detailed in the following embodiment with reference to FIG. 2. As shown in FIG. 2, the detection unit 130 includes a first multiplexer 132, a sampling amplifier 134, a sampling circuit 136, and a switch SW1. The first multiplexer 132 has a plurality of input terminals and an output terminal. The input terminals of the first multiplexer 132 are coupled to the touch panel 110 to respectively and correspondingly receive the touch signals s_t1 to s_tk, and the output terminal of the first multiplexer 132 sequentially outputs the touch signals s_t1 to s_tk.

The sampling amplifier 134 has a first input terminal, a second input terminal, and an output terminal. The first input terminal of the sampling amplifier 134 is coupled to the output terminal of the first multiplexer 132 to receive the touch signals s_t1 to s_tk, and the second input terminal of the sampling amplifier 134 is coupled to a ground voltage GND.

The sampling circuit 136 is coupled to the output terminal of the sampling amplifier 134 to receive the amplified touch signals s_t1 to s_tk. Here, the sampling circuit 136 includes the capacitor 138, and the sampling circuit 136 is controlled by a control signal set s_c and stores the touch signals s_t₁ to s_tk through the capacitor 138.

For instance, the sampling circuit 136 may have a circuit structure including switches SW2, SW3, and SW4 as well as the capacitor 138. Each of the switches SW2, SW3, and SW4 may be switched on or off according to corresponding control signals in the control signal set s_c and thereby samples the touch signals s_t1 to s_tk. As such, the capacitor 138 is charged in response to the touch signals s_t1 to s_tk and stores the touch signals s_t1 to s_tk. The control signal set s_c and its control signals corresponding to each switch may be provided by the signal generator 120.

After that, the sampling circuit 136 may further output the touch signals s_t1 to s_tk (stored by the capacitor 138) to an analog-to-digital convertor (not shown) for subsequent signal processing in order to detect and output the touch point on the touch panel 110.

The circuit structure of the sampling circuit 136 described herein is merely exemplary, and any circuit structure that may sample and maintain the touch signals s_t1 to s_tk falls within the scope of the sampling circuit 136 provided in the present embodiment.

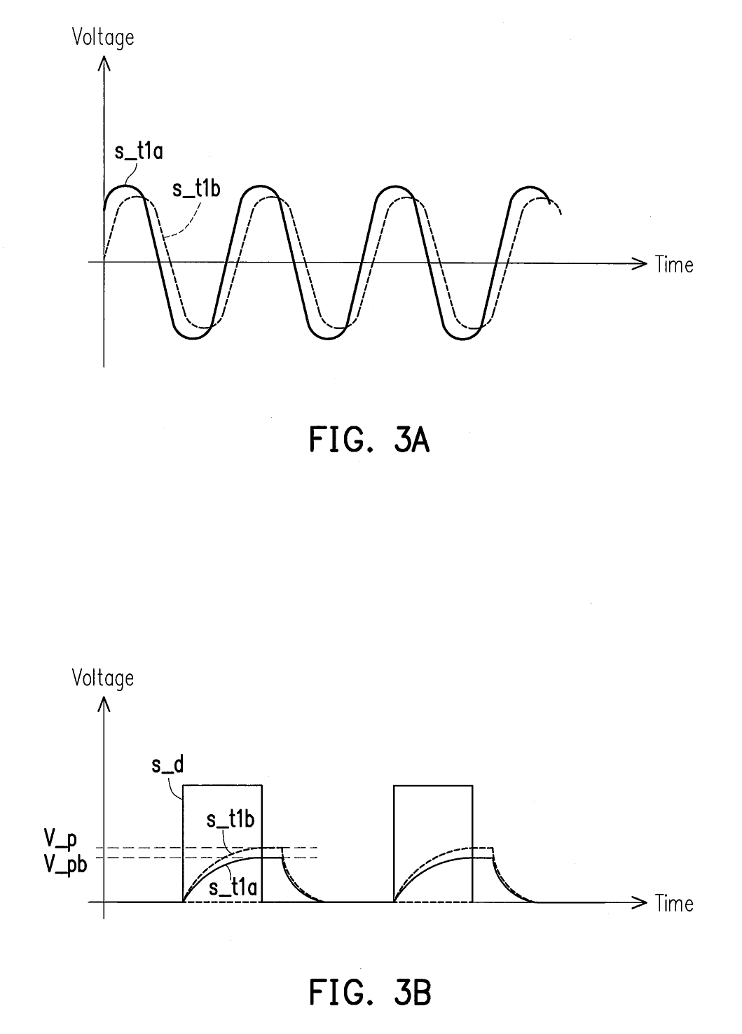

FIG. 3A and FIG. 3B are schematic views illustrating a signal waveform of a touch apparatus according to an embodiment of the invention. Here, the touch panel is a self capacitance touch panel, for instance, and the touch area TA_{—}11 is exemplified herein for elaborating driving and sensing actions on the touch areas. The driving signal s_d described in the embodiment shown in FIG. 3A has the sinusoid waveform, for instance; the driving signal s_d described in the embodiment shown in FIG. 3B has the square waveform, for instance. In other embodiments of the invention, the driving signal s_d may be a trapezoidal waveform or a triangular waveform, which should not be construed as a limitation of the invention.

With reference to FIG. 1 and FIG. 3A, when the touch panel 110 is initialized, the touch area TA_{—}11 that is not touched generates a touch signal s_t1 (as shown by the waveform s_t1a) according to the driving signal s_d with the sinusoid waveform. At this time, no phase difference exists between the touch signal s_t1 and the driving signal s_d.

When the touch area TA_{—}11 is touched, the equivalent capacitance of the touch area TA_{—}11 alters, and equivalent impedance may be calculated according to the following equation:

$$Z - R + j ( {X}_{L} - {X}_{C} ) - R + j ( ω L - \frac{1}{ω C} ) - R + j ( 2 π fL - \frac{1}{2 π fC} )$$

Here, X_{L}^{=2πfL} refers to an inductive impedance of the inductor, and

$${X}_{c} = \frac{1}{2 π fC}$$

refers to a capacitive impedance of the capacitor (unit: ohm).

At this time, the touch area TA_{—}11 that is touched generates a touch signal s_t1 (as shown by the waveform s_t1b) according to the driving signal s_d. Since the change to the equivalent capacitance equips the resonant circuit with capacitive properties, there exists a phase difference between the driving signal s_d and the touch signal s_t1 received by the detection unit 130. The detection unit 130 may then detect the touch point PT on the touched touch area TA_{—}11 according to the phase difference between the driving signal s_d and the touch signal s_t1 received by the detection unit 130.

With reference to FIG. 1, FIG. 2, and FIG. 3B, when the touch panel 110 is initialized, the touch area TA_{—}11 that is not touched generates a touch signal s_t1 (as shown by the waveform s_t1a) according to the driving signal s_d. At this time, the detection unit 130 receives the touch signal s_t1 and charges the capacitor 138 through the sampling circuit 136. As the peak voltage reaches and stays in a stable state, the peak voltage herein is defined as a peak base voltage V_pb.

When the touch area TA_{—}11 is touched, the equivalent capacitance of the touch area TA_{—}11 alters and may be calculated according to the above-mentioned equation. Here, the detection unit 130 receives the touch signal s_t1 with the waveform s_tlb shown in FIG. 3B. Based on the received touch signal s_t1, the detection unit 130 charges the capacitor 138 through the sampling circuit 136, calculates the capacitance variance of the touch area TA_{—}11 according to the peak voltage that reaches and stays in a stable state and the peak base voltage V_pb, and thereby detects and outputs a corresponding touch point PT on the touched touch area TA_{—}11.

For instance, when the touch area TA_{—}11 is not touched, the capacitance of the touch area TA_{—}11 is 5 pF, and the peak base voltage recorded by the detection unit 130 is 1.892 V. When the touch area TA_{—}11 is touched, and the capacitance of the touch area TA_{—}11 is raised to 5.1 pF, the peak voltage of the touch signal s_t1 detected by the detection unit 130 is correspondingly raised to 1.994 V, for instance. Hence, when the equivalent capacitance of the touch area TA_{—}11 is varied by 0.1 pF, the peak voltage of the touch signal s_t1 is correspondingly varied by 102 mV. That is, the capacitance variance of the touch area TA_{—}11 and the peak voltage variance of the touch signal s_t1 may be positively correlated to each other within a certain variance period (e.g., the capacitance variance rate is less than 10%). Said capacitance variance and said peak voltage variance are merely descriptive and are actually determined according to the design of the touch panel. In an experimental example, given that the default inductance is 470 μh, the capacitance variance by 0.01 pF may correspond to the peak voltage variance by 10 mV, and the capacitance variance by 1 pF may correspond to the peak voltage variance by 1.125 V. Besides, the inductance is positively correlated to the resonant frequency f, and thus the inductance of the inductor may be increased if the sensitivity of the touch panel is to be improved.

Conventionally, the number of charging and discharging a path of a capacitor is detected to determine whether the corresponding touch areas TA_{—}11 to TA_mn are touched. By contrast, in the touch apparatus 100 described in the present embodiment, the peak voltage variances of the touch signals s_t1 to s_tk may be detected to determine whether the corresponding touch areas TA_{—}11 to TA_nm are touched, and the sensing sensitivity of the touch apparatus may be further enhanced. In this case, even though the touch panel 110 is touched by a touch medium (e.g., a stylus) with a relatively small touch area, the detection unit 130 is able to accurately determine whether the corresponding touch areas TA_{—}11 to TA_nm are touched according to the peak voltage variances of the touch signals s_t1 to s_tk.

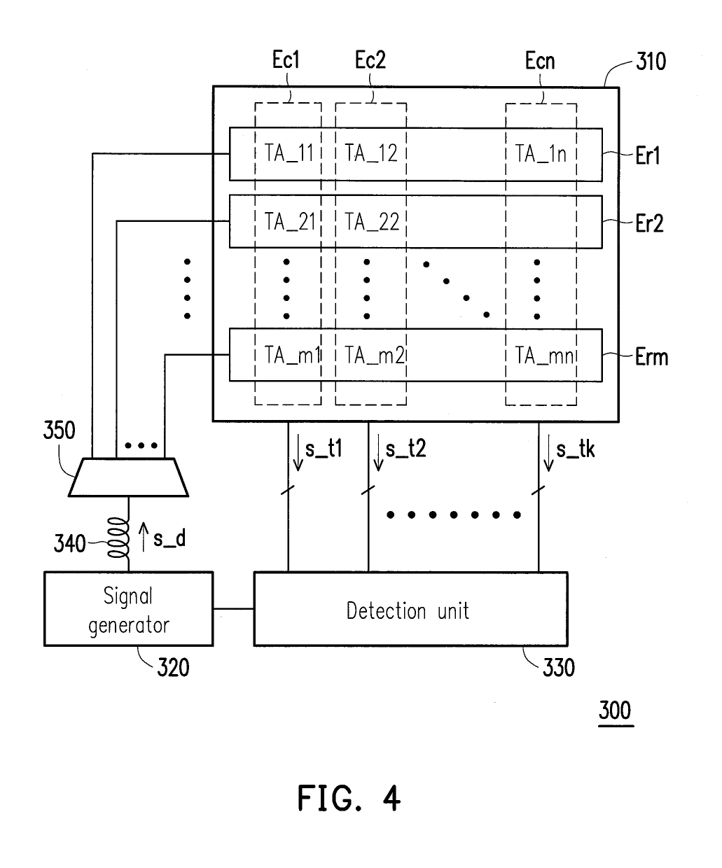

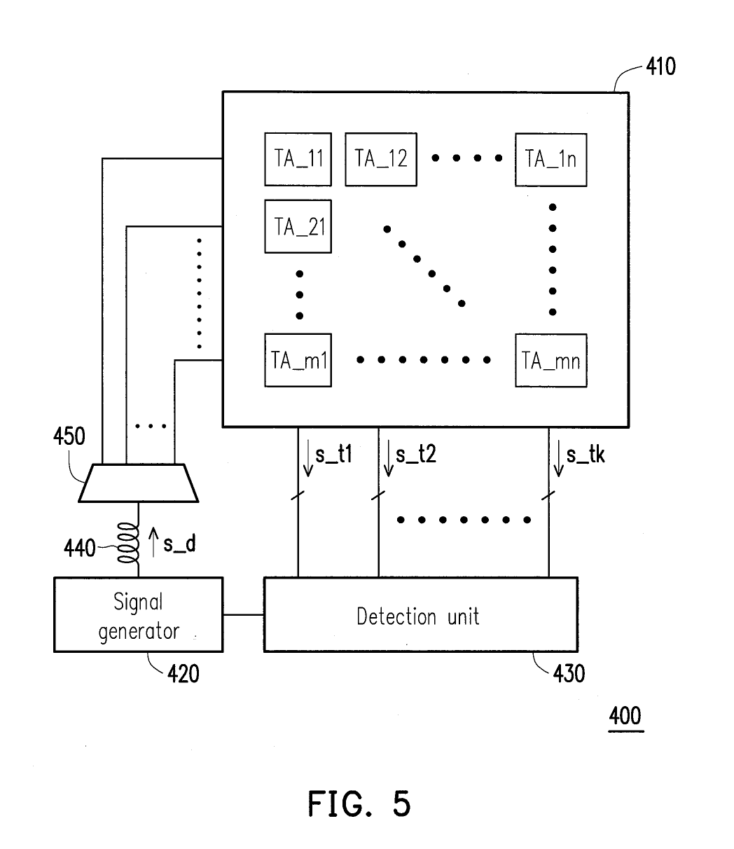

The following embodiments depicted in FIG. 4 and FIG. 5, a mutual capacitance touch mechanism and a self capacitance touch mechanism are respectively described to explain the touch apparatus herein.

FIG. 4 is a schematic view illustrating a touch apparatus according to another embodiment of the invention. Here, the touch panel 310 is a mutual capacitance touch panel which has touch areas TA_{—}11 to TA_nm arranged in m rows and n columns. The touch areas TA_{—}11 to TA_mn are constituted by overlapped areas between row electrodes Er1 to Erm vertically arranged in rows and column electrodes Ec1 to Ecn horizontally arranged in columns.

With reference to FIG. 4, the touch apparatus 300 includes the touch panel 310, a signal generator 320, a detection unit 330, an inductor 340, and a second multiplexer 350. The operational manner of the signal generator 320 and the detection unit 330 is substantially the same as that of the signal generator 120 and the detection unit 130 depicted in FIG. 1, and therefore no further description is provided hereinafter.

According to the present embodiment, the second multiplexer 350 has an input terminal and a plurality of output terminals. The input terminal of the second multiplexer 350 is coupled to the inductor 340 to receive the driving signal s_d through the inductor 340, and the output terminals of the second multiplexer 350 are respectively coupled to the corresponding row electrodes Er1 to Erm arranged in rows (i.e., coupled to one row of touch areas). After the driving signal s_d generated by the signal generator 320 is transmitted to the second multiplexer 350 through the inductor 340, the second multiplexer 350 supplies the touch areas TA_{—}11 to TA_{—}1n, TA_{—}21 to TA_{—}2n, . . . , and TA_m1 to TA_nm with the touch signals s_d row by row, such that the touch panel 310 outputs the touch signals s_t1 to s_tk respectively corresponding to the touch areas TA_{—}11 to TA_mn.

In particular, the signal generator 320 may, through the switch action of the second multiplexer 350, supply the touch signals s_d to the row electrodes Er1, Er2, and Erm row by row, such that the column electrodes Ec1 to Ecn arranged in the same row may, in response to the capacitance variance between the row electrodes Er1 to Erm and the column electrodes Ec1 to Ecn, output the touch signals s_t1 to s_tk respectively corresponding to the touch areas TA_{—}11 to TA_{—}1n, TA_{—}21 to TA_{—}2n and TA_m1 to TA_mn.

For instance, when the driving signal s_d is provided to the row electrode Er1 through the second multiplexer 350, each of the column electrodes Ec1 to Ecn may respond to the driving signal s_d on the row electrode Er1 and output the touch signals s_t1 to s_tk respectively corresponding to the touch areas TA_{—}11 to TA_{—}1n, e.g., the column electrode Ec1 outputs the touch signal s_t1 corresponding to the touch area TA_{—}11, the column electrode Ec2 outputs the touch signal s_t2 corresponding to the touch area TA_{—}12, and so on. After the detection unit 330 receives the touch signals s_t1 to s_tk respectively corresponding to the touch areas TA_{—}11 to TA_{—}1n, the driving signal s_d is, in response to the switch action of the second multiplexer 350, provided to the row electrode Er2. Similarly, each of the column electrodes Ec1 to Ecn may output the touch signals s_t1 to s_tk respectively corresponding to the touch areas TA_{—}21 to TA_{—}2n, e.g., the column electrode Ec1 outputs the touch signal s_t1 corresponding to the touch area TA_{—}21, the column electrode Ec2 outputs the touch signal s_t2 corresponding to the touch area TA_{—}22, and so on. Thereby, the second multiplexer 350 may perform the switch action sequentially in the aforesaid manner and provide the driving signal s_d to each of the row electrodes Er1 to Erm, such that the detection unit 330 may receive the touch signal s_t1 to s_tk corresponding to the touch areas TA_{—}11 to TA_mn.

On the other hand, the second multiplexer 350 may sequentially provide the driving signal s_d row by row in a reverse direction, e.g., sequentially provide the driving signal s_d to the row electrodes Erm, Erm-1, Er2, and Er1.

In another embodiment of the invention, the touch panel 310 may also be driven in a self capacitance driving manner. For instance, the second multiplexer 350 may sequentially provide the driving signal s_d to each of the row electrodes Er1 to Erm and then sequentially provide the driving signal s_d to each of the column electrodes Ec1 to Ecn, such that each of the row electrodes Er1 to Erm and each of the column electrodes Ec1 to Ecn respectively respond to the received driving signal s_d and transmit the touch signals s_t1 to s_tk back. The detection unit 330 may then receive the touch signals s_t1 to s_tk generated by each of the row electrodes Er1 to Erm and each of the column electrodes Ec1 to Ecn.

In the touch panel 310, the capacitance respectively corresponding to the touch areas TA_{—}11 to TA_mn may alter if the touch areas TA_{—}11 to TA_mn are touched, and the peak voltages of the touch signals s_t1 to s_tk may be determined according to the capacitance respectively corresponding to the touch areas TA_{—}11 to TA_mn. Accordingly, the detection unit 330 may calculate the capacitance variances of the touch areas TA_{—}11 to TA_mn according to the difference between the peak base voltages and the peak voltages of the touch signals s_t1 to s_tk and thereby detect the touch point on the touch panel 310, i.e., detect whether the touch areas TA_{—}11 to TA_mn are touched.

FIG. 5 is a schematic view illustrating a touch apparatus according to still another embodiment of the invention. Here, the touch panel 410 is a self capacitance touch panel which also has touch areas TA_{—}11 to TA_nm arranged in m rows and n columns, for instance. The touch areas TA_{—}11 to TA_nm respectively correspond to the electrode areas of the electrodes arranged in arrays.

With reference to FIG. 5, the touch apparatus 400 includes the touch panel 410, a signal generator 420, a detection unit 430, an inductor 440, and a third multiplexer 450. The operational manner of the signal generation unit 420 and the detection unit 430 is substantially the same as that of the signal generator 120 and the detection unit 130 depicted in FIG. 1, and therefore no further description is provided hereinafter.

According to the present embodiment, the third multiplexer 450 has an input terminal and a plurality of output terminals. The input terminal of the third multiplexer 450 is coupled to the inductor 440 to receive the driving signal s_d through the inductor 440, and the output terminals of the third multiplexer 450 are respectively coupled to the touch areas TA_{—}11 to TA_nm. After the driving signal s_d generated by the signal generator 420 is transmitted to the third multiplexer 450 through the inductor 440, the third multiplexer 450 sequentially supplies the touch areas TA_{—}11 to TA_mn with the touch signals s_d, such that the touch areas TA_{—}11 to TA_mn output the corresponding touch signals s_t1 to s_tk.

In particular, the signal generator 420 may, through the switch action of the third multiplexer 450, sequentially provide the driving signal s_d to the touch areas TA_{—}11 to TA_mn of the touch panel 410. For instance, the third multiplexer 450 may perform the switch action to sequentially provide the driving signal s_d to each of the touch areas (e.g., TA_{—}11, TA_{—}12, . . . , and TA_{—}1n) in the first row, to each of the touch areas (e.g., TA_{—}21 to TA_{—}2n) in the second row, and so on. The direction in which the driving signal s_d is provided to each of the touch areas in each row may be from left to right of the drawings, from right to left of the drawings, or from the center to the left and the right of the drawings (i.e., from the center of the drawing to the peripheries of the touch panel 410), which may be determined by people having ordinary skill in the art.

Besides, the driving signal s_d is provided in the order of the first row, the second row, . . . , and the last row; in another embodiment of the invention, however, the driving signal s_d may be provided in the order from the last row to the first row. The invention is not limited thereto.

From another perspective, the third multiplexer 450 may perform the switch action to sequentially provide the driving signal s_d to each of the touch areas (e.g., TA_{—}11, TA_{—}21, . . . , and TA_m1) in the first column, to each of the touch areas (e.g., TA_{—}12 to TA_m2) in the second column, and so on. The direction in which the driving signal s_d is provided to each of the touch areas in each column may be from top to bottom of the drawings, from bottom to top of the drawings, or from the center to the top and the bottom of the drawings (i.e., from the center of the drawing to the peripheries of the touch panel 410), which may be determined by people having ordinary skill in the art.

Besides, the driving signal s_d is provided in the order of the first column, the second column, . . . , and the last column; in another embodiment of the invention, however, the driving signal s_d may be provided in the order from the last column to the first column. The invention is not limited thereto.

The above-mentioned order of providing the driving signal s_d to the corresponding touch areas TA_{—}11 to TA_nm is merely exemplary, and people having ordinary skill in the art may, through the third multiplexer 450, provide the driving signal s_d to the corresponding touch areas TA_{—}11 to TA_nm in any desired order, which should not be construed as a limitation to the invention.

In the self capacitance touch panel 410, the capacitance respectively corresponding to the touch areas TA_{—}11 to TA_nm may alter if the touch areas TA_{—}11 to TA_mn are touched, and the peak voltages of the touch signals s_t1 to s_tk may be determined according to the capacitance respectively corresponding to the touch areas TA_{—}11 to TA_mn. Accordingly, the detection unit 430 may sense the capacitance variances of the touch areas TA_{—}11 to TA_mn according to the difference between the peak base voltages and the peak voltages of the touch signals s_t1 to s_tk and thereby detect the touch point on the touch panel 410, i.e., detect whether the touch areas TA_{—}11 to TA_mn are touched.

It should be mentioned that the detection unit 430 described in the present embodiment receives the driving signal s_d and the touch signals s_t1 to s_tlk through different transmission paths. However, in another embodiment of the invention, the detection unit 430 may receive the driving signal s_d and the touch signals s_t1 to s_tlk through the same transmission path. Namely, after the touch areas TA_{—}11 to TA_nm receive the driving signal s_d through the corresponding transmission path, the touch areas TA_{—}11 to TA_nm correspondingly transmit the touch signals s_t1 to s_tk back to the detection unit 430 through the same transmission path.

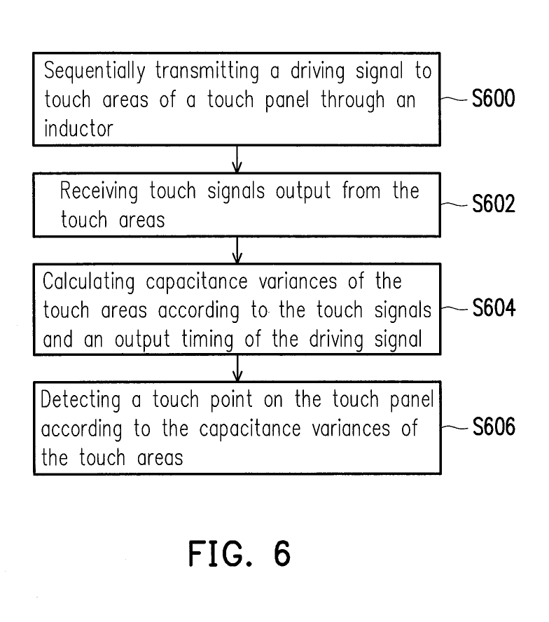

FIG. 6 is a schematic view illustrating a touch sensing method according to an embodiment of the invention. With reference to FIG. 6, in step S600, a driving signal (e.g., the driving signal s_d) is sequentially transmitted to a plurality of touch areas of a touch panel (e.g., the touch panel 110, 310, or 410) through an inductor (e.g., the inductor 140, 340, or 440). After the touch areas receive the driving signal, each touch area responds to the driving signal and outputs a plurality of touch signals (e.g., the touch signals s_t1 to s_tk), such that a detection unit (e.g., the detection unit 130, 330, or 430) receives the touch signals output from the touch areas (step S602). After the detection unit calculates capacitance variances of the touch areas according to the touch signals and an output timing of the driving signal in step S604, the detection unit further detects a touch point on the touch panel according to the capacitance variances of the touch areas in step S606.

The details of transmitting the driving signal to the touch areas (step S600) through the inductor and calculating the capacitance variances of the touch areas (step S606) may be referred to as those described in the previous embodiments depicted in FIG. 1 to FIG. 5, and therefore no further description is provided hereinafter.

To sum up, in the touch apparatus described in an embodiment of the invention, whether the capacitance of each touch area of the touch panel is varied may be determined by detecting the peak voltage variances of the touch signals; thereby, the touch point on the touch panel may be detected, and the sensing sensitivity of the touch apparatus may be enhanced.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A touch apparatus comprising:
a touch panel having a plurality of touch areas;
a signal generation unit for generating a driving signal;
an inductor coupled between the touch panel and the signal generation unit for transmitting the driving signal to the touch areas; and
a detection unit coupled to the touch panel and the signal generation unit for receiving a plurality of touch signals output from the touch areas and calculating capacitance variances of the touch areas according to the touch signals and an output timing of the driving signal, so as to detect a touch point on the touch panel,
wherein a frequency of the driving signal is equal to a resonant frequency of a reference capacitance of the touch panel and an inductance of the inductor.

2. The touch apparatus as recited in claim 1, wherein the detection unit comprises:
a first multiplexer having a plurality of input terminals and an output terminal, the input terminals of the first multiplexer being coupled to the touch panel to respectively and correspondingly receive the touch signals, the output terminal of the first multiplexer sequentially outputting the touch signals;
a sampling amplifier having a first input terminal, a second input terminal, and an output terminal, the first input terminal of the sampling amplifier being coupled to the output terminal of the first multiplexer to receive the touch signals, the second input terminal of the sampling amplifier being coupled to a ground voltage; and
a sampling circuit coupled to the output terminal of the sampling amplifier to receive amplified touch signals and sample peak voltages of the amplified touch signals.

3. The touch apparatus as recited in claim 1, wherein the detection unit calculates the capacitance variances of the touch areas according to variances in peak voltages of the touch signals.

4. The touch apparatus as recited in claim 3, wherein when the touch panel is not touched, the peak voltages of the touch signals are peak base voltages, and when the touch panel is touched, the detection unit detects the capacitance variances of the touch areas according to the peak base voltages and the peak voltages of the touch signals.

5. The touch apparatus as recited in claim 1, wherein the touch panel is a mutual capacitance touch panel, and the touch areas are supplied with the touch signals row by row.

6. The touch apparatus as recited in claim 5, further comprising a second multiplexer, the second multiplexer having an input terminal and a plurality of output terminals, the input terminal of the second multiplexer being coupled to the inductor to receive the driving signal through the inductor, the output terminals of the second multiplexer being respectively coupled to one row of the touch areas.

7. The touch apparatus as recited in claim 1, wherein the touch panel is a self-capacitance touch panel.

8. The touch apparatus as recited in claim 7, further comprising a third multiplexer, the third multiplexer having an input terminal and a plurality of output terminals, the input terminal of the third multiplexer being coupled to the inductor to receive the driving signal through the inductor, the output terminals of the third multiplexer being respectively coupled to the touch areas.

9. The touch apparatus as recited in claim 1, wherein the reference capacitance is an average of capacitances corresponding to the touch areas.

10. The touch apparatus as recited in claim 1, wherein the reference capacitance is an average of a maximum capacitance and a minimum capacitance of capacitances corresponding to the touch areas.

11. The touch apparatus as recited in claim 1, wherein the driving signal has one of a sinusoid waveform, a square waveform, a trapezoidal waveform, and a triangular waveform.

12. A touch sensing method comprising:
sequentially transmitting a driving signal to a plurality of touch areas of a touch panel through an inductor;
receiving a plurality of touch signals correspondingly output from the touch areas;
calculating capacitance variances of the touch areas according to the touch signals and an output timing of the driving signal; and
detecting a touch point on the touch panel according to the capacitance variances of the touch areas.

13. The touch sensing method as recited in claim 12, wherein the step of calculating the capacitance variances of the touch areas according to the touch signals and the output timing of the driving signal comprises:
calculating the capacitance variances of the touch areas according to variances in peak voltages of the touch signals.

14. The touch sensing method as recited in claim 13, wherein the step of calculating the capacitance variances of the touch areas according to the variances in the peak voltages of the touch signals comprises:
setting the peak voltages of the touch signals as peak base voltages when the touch panel is not touched; and
determining the capacitance variances of the touch areas according to the peak base voltages and the peak voltages of the touch signals.
